(19) United States
(12) Patent Application Publication
(10) Pub. No.: US 2007/0286762 A1
(43) Pub. Date: Dec. 13, 2007

(54) Gold-containing solder deposit, method for production thereof, soldering method and use

(76) Inventor: Herman Oppermann, Berlin (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/785,055

(22) Filed: Apr. 13, 2007

(30) Foreign Application Priority Data
Apr. 13, 2006 (DE) 10 2006 017 536.0
Nov. 10, 2005 (DE) 10 2006 053 146.9

(51) Int. Cl. C22C 5/02; B05D 5/12; B23K 31/02; C22C 13/00

(52) U.S. Cl. 420/507; 228/101; 420/557; 427/125

(57) ABSTRACT

The present invention relates to a solder deposit which can be produced by alloying at least one gold layer and tin layer on a wetting metal (first substrate). In addition, the present invention relates to a soldering method for soldering at least two substrates using solder deposits according to the invention, a defined temperature for melting not being exceeded and the second substrate having a higher proportion of gold than the solder deposit.

The present invention relates to a solder deposit which can be produced by alloying at least one gold layer and tin layer on a wetting metal (first substrate). In addition, the present invention relates to a soldering method for soldering at least two substrates using solder deposits according to the invention, a defined temperature for melting not being exceeded and the second substrate having a higher proportion of gold than the solder deposit.

At present, thin layers are produced galvanically or by sputtering or by evaporation coating. As a rule, the solder is produced on one side and a wettable metallisation is produced on the opposite side.

For example, Au/Sn solder with the eutectic composition Au/Sn 80/20 is produced by evaporation coating or sputtering. The eutectic solder comprises the two phases Au₅Sn and AuSn. During assembly, further gold can be made available from the counter-part in order to shift the solder composition and to obtain a higher-melting alloy. In order to increase the quantity of alloyed gold and hence to extend the soldering time, a solder composition (Au/Sn 70/30) which is richer in tin is offered in part. The 70/30 solder thereby likewise comprises the 2 phases Au₅Sn and AuSn but with an excess of the AuSn phase so that the solder only melts partially at the eutectic temperature (280° C). In the method described in prior art, the aim is not however to protect the wetting metal beneath the solder from dissolving.

The object of the present invention is to provide a method for the production of a solder deposit, and a solder deposit with which dissolving of a wetting metal situated thereunder can be extensively prevented. It is likewise the object of the invention to indicate a soldering method with which at least two substrates can be soldered together without dissolving of the wetting metal present being effected.

This object is achieved by the method for producing a solder deposit having the features of claim 1 and also by the solder deposit having the features of claim 15. The object, that the wetting metal is retained during a soldering process, is achieved with the soldering method having the features of claim 18. Claim 27 indicates uses of the method. The dependent claims represent advantageous developments.

According to the invention a method for producing a solder deposit is provided, in which at least one layer which contains gold and one which contains tin is applied in layers on a wetting material, the molar ratio of gold to tin being between 70:30 to 33:67 and a subsequent temperature treatment being effected, the temperature and duration of which are adapted to each other such that it is ensured that the at least one gold layer and tin layer react to form an alloy.

In general, two different embodiments are thereby conceivable. On the one hand, it can be advantageous that gold and tin are applied respectively in one layer. It is thereby very particularly advantageous if the layer thicknesses of the gold layer and/or tin layer are in the range between 1 μm and 50 μm, preferably between 2 μm and 20 μm, very particularly preferred between 2 μm and 15 μm.

In an alternative preferred embodiment, the gold and the tin are applied respectively in at least two alternate layers. It is thereby advantageous if the layer thicknesses for a gold layer and/or tin layer respectively, independently of the at least one other layer, are in the range of 0.1 μm and 5 μm, preferably between 0.25 μm and 2.5 μm, very particularly preferred between 0.5 μm and 1 μm.

It is thereby useful if the layers are applied on each other in a covering manner, i.e. in a form fit. The layers can thereby have any geometrical configuration, as a function of the respective purpose of use, for example rectangular, round, annular or asymmetrical.

It is a particular advantage of the solder deposit that the wetting metal (first substrate) need thereby merely fulfil the proviso that it has a melting point of more than 500° C. Hence a multiplicity of metals and alloys is conceivable. The wetting metal is however selected preferably from the group comprising nickel, palladium, platinum, titanium, silver and/or alloys. The wetting metal can optionally be provided with a thin gold layer having a thickness in the range of for example 0.1 to 10 μm for protection against oxidation.

It is advantageous if the molar ratio of gold and tin of the solder deposit is between 60:40 and 40:60, for further preference between 55:45 and 45:55, very particularly preferred at 50:50.

If such a deposit is produced in two steps by successive deposition of gold and tin and subsequent temperature treatment, then the AuSn phase can be produced with suitable selection of the molar ratio.

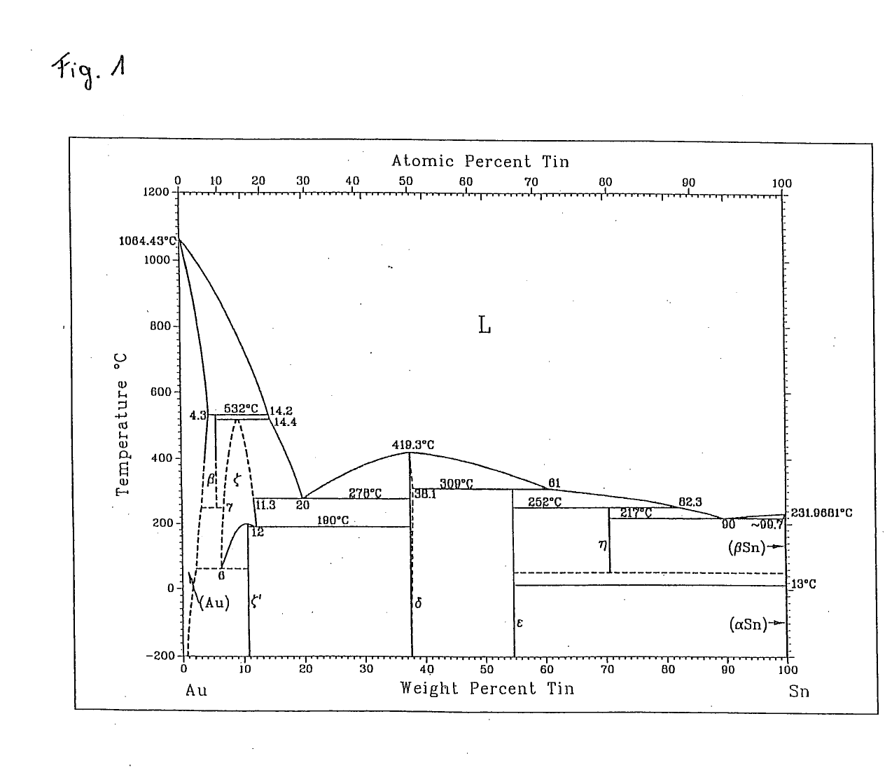

It is thereby useful if the temperature is chosen between 180° C and 500° C., preferably between 180° C. and 419.3° C., further preferred between 250 and 340° C., further preferred between 250 and 309° C., very particularly preferred between 250 and 278° C. The temperature is thereby selected in particular according to the composition of the solder deposit. Hence for gold-rich compositions, a temperature between 250° C. and 278° C. should be preferred (eutectic reaction of AuSn₂₀) and between 250° C. and 309° C. for the peritectic reaction of the AuSn₂ phase). During this heat treatment, the alloy is produced according to the invention by diffusion. The temperatures thereby used do not however suffice to melt the alloy. If the AuSn composition (50:50) is reached, the solder does not melt below 419.3° C. (see also the phase diagram of an AuSn system reproduced in FIG. 1). However it is also conceivable that further metals are also present in the alloy apart from Au and Sn, so that at least a three phase system is present. As a result, a melting temperature of the system can also preferably be set which is above or below the monotectic melting temperature of the intermetallic AuSn phase. In the case of a two-component system comprising Au and Sn in the molar ratio of 50:50, it is however preferred if the temperature is chosen below 419.3° C.

In an embodiment which is to be preferred, the temperature treatment is thereby effected over a period of time of fractions of seconds via several minutes to several hours, according to the temperature and the concentration gradient which is to equalised by the diffusion.

Preferably the temperature treatment thereby lasts between 0.1 s to 5 hours, preferably between 0.2 s and 60 min.

In a further advantageous embodiment, the solder deposit is covered during the temperature treatment by a liquid with a boiling point of above 250° C.

Advantageously, the liquid is thereby selected from the group comprising glycerine, oils, alcohols and/or sugars.

The particular advantage in the case of such a production of a solder deposit comprising gold and tin is that the dissolving of the wetting metal situated thereunder is virtually prevented since melting of the gold- and tin-containing alloy is prevented. Hence conveyance of the wetting metal, e.g. nickel, by solution and convection into the solder is not possible; the conveyance is effected exclusively by the much lesser and more inefficient solid body diffusion.

According to the invention, a solder deposit is likewise provided, the molar ratio of gold to tin being between 70:30 to 33:67 and the alloy being applied on a wetting metal over the entire surface or in regions.

Preferably, the solder deposit has a thickness, so that sufficient material is present, which ensures a solder of good quality with a further substrate. The layer thickness is hence dependent merely upon the purpose of use or the further substrate. Advantageously, the thickness of the solder deposit is between 0.2 and 100 μm, preferably between 1 and 20 μm, particularly preferred between 2 and 5 μm.

The solder deposit can thereby be produced advantageously according to the above-indicated method but alternative production methods are also conceivable, for example separate production of the alloy in the desired layer thickness and subsequent application onto the wetting metal.

According to the invention, a method for soldering at least two substrates is also provided, using a solder deposit having the above-described features, said method being characterised in that the solder deposit is brought in contact at a temperature which is below 500° C. with a second substrate which has a higher proportion of gold.

It is thereby advantageous if the second substrate has a coating made of gold or a coating made of an alloy which contains gold and the solder deposit is brought in contact with this coating. It is thereby an advantage according to the invention that the actual matrix of the second substrate on which the gold-containing coating is applied, can comprise the most varied types of materials. Hence the soldering method according to the invention can be applied to all possible materials, the only condition thereby is that the respective materials are coated with a gold-containing coating which has a higher proportion of gold than the solder deposit.

If the components of the solder deposit are merely gold and tin, it is thereby preferred if the temperature of the soldering method is below 419.3° C. This hereby concerns the monotectic melting point of the intermetallic AuSn phase. However, by adding further metals to the solder deposit, also higher melting points are however conceivable so that a temperature increase in the method is conceivable, which must however be below 500° C. in order to prevent excessive dissolving of the wetting metal.

It must also be preferred according to the invention that the temperature during the soldering process is at least 280° C., preferably at least 320° C.

The advantage according to the invention thereby arises that the solder deposit melts upon contact with the at least one further substrate. The gold proportion both of the solder deposit and of the second substrate can hereby be set so high that the solder formed together has a eutectic composition or else is alloyed with so much gold that the solder is converted and resolidified in Au₅Sn which has a melting point of 520° C.

As a result of the higher proportion of gold of the at least one further substrate, it is ensured that gold diffuses into the liquefied solder deposit from the at least one further substrate. It is thereby very particularly advantageous if concentration of gold is effected until the solidus temperature of the new alloy formed together is fallen below and hence if the solder point again becomes solid. This has the advantage that, by heating once during the soldering process, both melting and resolidifying of the solder is ensured and hence short soldering processes are made possible. It is thereby advantageous if gold diffuses into the solder until the molar ratio of gold to tin is between 90:10 and 25:75, preferably between 85:15 and 50:50. Preferably the Au₅Sn phase is thereby formed which has a melting point of 520° C. and hence is above the maximum soldering temperature which is used.

Advantageously the soldering takes place under an inert and/or reducing atmosphere.

The method is applied according to the invention in the production of electronic components. These can be selected preferably from the group comprising printed circuit boards, power amplifiers, heat expanders, heat sinks, diodes, transistors and/or power components.

The components can likewise be optoelectronic components, selected for example from the group comprising lasers, laser bars, LEDs, photodiodes, modulators, photodetectors and/or monitor diodes.

In addition, the components can be sensors which are intended to be soldered for example closely adjacent to each other on a printed circuit board.

In addition, components can be soldered onto a wafer as individual electronic circuits (ICs). This method allows further application of wafer level processes after complete fitting of the wafer. Instead of ICs, also covers made of silicon, glass, ceramic or metal can be mounted with solder on an IC wafer or an MEMS wafer.

Use is likewise made possible in which the components are sensors which are intended to be soldered closely adjacent to each on a printed circuit board.

A further use option is that the components are soldered onto a wafer as individual electronic circuits (ICs).

In addition, components, for example covers made of silicon, glass, ceramic or metal, can be soldered onto an IC wafer or an MEMS wafer.

In general the method is suitable in particular for producing components with high power loss which are intended to have a thin solder layer because of low heat transfer. However the method is also advantageous for other applications if merely a small solder layer thickness is required for different constructional reasons. In addition, this method is advantageous if the wafer (or a substrate with many adjacent mounting places) with the components to be fitted can be kept at a higher temperature and the solder melts only upon contact with the component and, in this way, all other solder deposits without contact with the component remain solid and react substantially more slowly with a wetting metal situated thereunder.

The subsequently illustrated FIG. 1 shows a phase diagram of the gold-tin system.

The present invention is explained in more detail with reference to the subsequent examples without intending to restrict the invention to the features of the examples.

### EXAMPLE 1

### Production of a Solder Deposit Comprising Two Layers

A gold layer of 2 μm thickness and a tin layer of 3 μm thickness are applied on a deposited wetting metal (nickel) with a layer thickness of 2 μm. The two layers together produce a composition of the eutectic AuSn phase. Homogenisation of the AuSn phase is achieved by diffusion after a heat treatment at 200° C. for 1 hour.

### EXAMPLE 2

### High Solder Deposit

The production of a high solder deposit is effected analogously to example 1, only gold is applied in a layer thickness of 10 μm and tin in a layer thickness of 15 μm.

### EXAMPLE 3

### Solder Deposit Comprising Alternate Gold and Tin Layers

Analogously to example l, alternately gold and tin layers are applied on a wetting metal (nickel, layer thickness 5 μm), the total layer thickness thereof corresponding to the composition of the AuSn. In addition, firstly a gold layer with a thickness 0.5 μm is applied, subsequently a tin layer of 1 μm thickness, subsequently again a gold layer of 0.5 μm and a tin layer of 1 μm, finally a gold layer of 0.5 μm thickness. The coating process can be continued to any extent so that, analogously to example 2, also high solder deposits can thus be produced. A homogeneous phase is achieved by diffusion after a heat treatment.

### EXAMPLE 4

### Soldering Process

A component coated with gold is brought in contact with the solder deposit so that the gold is alloyed into the solder deposit; the solder deposit thereby becomes liquid. Further gold which diffuses into the solder deposit shifts the composition towards gold-rich so that the solder resolidifies at the temperature as Au₅Sn. The melting point of Au₅Sn is thereby 520° C. The temperature during the soldering process is thereby between 280° C. and 419° C., the soldering process is preferably implemented at 320° C.

### EXAMPLE 5

### Soldering Method with a Gold-Coated Substrate

The method is implemented analogously to example 4, only the substrate thereby used does not comprise gold but has a gold layer. Alternatively thereto, it is also possible that a layer which comprises a gold-containing alloy is used. The only crucial criterion thereby is that the component of gold of the layer must thereby exceed that of the solder deposit.

### EXAMPLE 6

### Soldering Process Using High-Boiling Liquids

During the soldering process which is implemented analogously to example 4, the substrate used is covered with glycerine during the temperature treatment and the temperature is raised to 280° C. Since the boiling point of the glycerine is 280° C., a further temperature increase can hence advantageously be restricted even when supplying higher power.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding German application No. 10 2006 017 536.0, filed Apr. 13, 2006 and German application No. 10 2006 053 146.9, filed Nov. 10, 2005, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A method for producing a solder deposit, said method comprising:
applying at least one layer which contains gold and one layer which contains tin onto on a wetting metal, the molar ratio of gold to tin being between 70:30 to 33:67; and
subsequently subjecting said layers to a temperature treatment the temperature and duration of which are adapted to each other such that the at least one gold layer and tin layer react to form an alloy.

2. A method according to claim 1, wherein gold and tin are applied, respectively, in one layer.

3. A method according to claim 2, wherein the layer thicknesses for the gold layer and/or tin layer are in the range between 1 μm and 50 μm.

4. A method according to claim 1, wherein gold and tin are applied, respectively, in at least two alternate layers.

5. A method according to claim 4, wherein the layer thicknesses for a gold layer and/or tin layer, independently of the at least one other layer, are in the range between 0.1 μm and 5 μm.

6. A method according to claim 1, wherein the layers are applied on each other in a covering manner.

7. A method according to claim 1, wherein the layers have a rectangular, round, annular or asymmetrical configuration.

8. A method according to claim 1, wherein the wetting metal is selected from nickel, palladium, platinum, titanium, silver and alloys thereof.

9. A method according to claim 1, wherein the wetting metal has a gold layer for protection against oxidation.

10. A method according to claim 1, wherein gold and tin are used in a molar ratio of 60:40 to 40:60.

11. A method according to claim 1, wherein the temperature is chosen between 180° C. and 500° C.

12. A method according to claim 1, wherein the temperature treatment is effected over a period of time between 0.1 s to 5 hours.

13. A method according to claim 1, wherein the solder deposit is covered during the temperature treatment by a liquid with a boiling point of above 250° C.

14. A method according to claim 13, wherein the liquid is selected from glycerine, oils, alcohols, sugars, and combinations thereof.

15. A solder deposit containing an alloy of gold and tin, the molar ratio of gold to tin being between 70:30 to 33:67 and the alloy being applied on a wetting metal.

16. A solder deposit according to claim 15, wherein the thickness of the solder deposit is between 0.2 and 100 μm.

17. A solder deposit producible according to claim 1.

18. A method for soldering at least two substrates comprising soldering said at least two substrates using a solder deposit according to claim 15, wherein said solder deposit is brought in contact at a temperature below 500° C. with a second substrate which has a higher proportion of gold.

19. A method according to claim 17, wherein the second substrate has a coating made of gold or an alloy which contains gold, and said solder deposit is brought in contact with the coating.

20. A method according to claim 18, wherein the contact temperature is below 419.3° C.

21. A method according to claim 18, wherein the contact temperature is at least 280° C.

22. A method according to claim 18, wherein the solder deposit melts upon contact with the second substrate.

23. A method according to claim 18, wherein gold of the second substrate diffuses into the liquefied solder deposit.

24. A method according to claim 18, wherein gold diffuses from the second substrate into the solder deposit until the solidus temperature thereof is fallen below and the solder deposit becomes solid.

25. A method according to claim 18, wherein gold diffuses into the solder deposit until the molar ratio of gold to tin is between 90:10 and 25:75.

26. A method according to claim 18, characterised in that the operation takes place under an inert and/or reducing atmosphere.

27. A method according to claim 18, wherein said at least two substrates are parts of electronic or optoelectronic components.

28. A method according to claim 27, wherein the components are selected printed circuit boards, power amplifiers, heat expanders, heat sinks, sensors, transistors, and other power components.

29. A method according to claim 27, wherein the components are optoelectronic components.

30. A method according to claim 29, wherein the components are selected from lasers, laser bars, LEDs, photodiodes, photosensors, modulators, photodetectors, and monitor diodes.

31. A method according to claim 27, wherein the components are sensors which are intended to be soldered closely adjacent to each other on a printed circuit board.

32. A method according to claim 27, wherein the components are soldered onto a wafer as individual electronic circuits (ICs).

33. A method according to claim 27, wherein the components are covers made of silicon, glass, ceramic or metal and are soldered onto an IC wafer or an MEMS wafer.
